(19) United States
(12) Patent Application Publication
(10) Pub. No.: US 2016/0152828 A1
(43) Pub. Date: Jun. 2, 2016

(54) COMPOSITION FOR PREPARING POLYETHERIMIDE/POLYESTER BLEND CHIP AND METHOD FOR PREPARING THE SAME

(71) Applicant: TAIWAN TEXTILE RESEARCH INSTITUTE, NEW TAIPEI CITY (TW)

(72) Inventors: Lung-Chang Hung, New Taipei City (TW); Sheng-Shan Chang, New Taipei City (TW); Chun-Hung Lin, New Taipei City (TW); Nai-Yun Liang, New Taipei City (TW)

(21) Appl. No.: 14/568,260

(22) Filed: Dec. 12, 2014

(30) Foreign Application Priority Data
Dec. 1, 2014 (TW) 103141625

(51) Int. Cl. C08L 79/08; G02B 1/04; C08J 3/12

(52) U.S. Cl. CPC C08L 79/08; C08J 3/12; G02B 1/04; C08J 2379/08; C08J 2467/02

(57) ABSTRACT

A composition for preparing a polyetherimide/polyester blend chip includes a polyetherimide powder and a polyester powder, in which the polyetherimide powder has an amount greater than 70 wt % and less than or equal to 90 wt % based on a total weight of the polyetherimide powder and the polyester powder, and the polyester powder has an amount greater than or equal to 10 wt % and less than 30 wt % based on the total weight of the polyetherimide powder and the polyester powder. The polyetherimide/polyester blend chip made of the composition is amorphous.

### RELATED APPLICATIONS

This application claims priority to Taiwanese Application Serial Numbers 103141625, filed Dec. 1, 2014, which is herein incorporated by reference.

### BACKGROUND

1. Field of Invention

The present disclosure relates to a composition for preparing a polyetherimide/polyester blend chip, a method for preparing the polyetherimide/polyester blend chip, the polyetherimide/polyester blend chip, and an article made of the polyetherimide/polyester blend chip.

2. Description of Related Art

Polyetherimide/polyester can be used to produce a transparent article. However, transparency of the article may not be able to reach an optical grade. Further, the higher the content of the polyester, the lower the transparency of the article is. If the content of the polyetherimide is higher, the transparency can be improved, but fluidity becomes poor, and thus the polyetherimide/polyester needs to be processed at a high temperature (e.g., 350° C. or higher), which is not conducive to processability. Therefore, there is still a need of a polyetherimide/polyester having good processability and able to reach optical-grade transparency.

### SUMMARY

The present disclosure provides a composition for preparing a polyetherimide/polyester blend chip, which includes a polyetherimide powder and a polyester powder. The prepared polyetherimide/polyester blend chip is amorphous with an amount of the polyester greater than or equal to 10 wt % and less than 30 wt % because of the use of the polyetherimide “powder” and the polyester “powder”.

The present disclosure further provides a composition for preparing a polyetherimide/polyester blend chip, which includes a polyetherimide powder, a polyester powder and an additive. The prepared polyetherimide/polyester blend chip is amorphous with an amount of the polyester greater than or equal to 10 wt % and less than 35 wt % because of the use of the additive. The amorphous polyetherimide/polyester blend chip can be used to produce an optical connector element.

The composition for preparing the polyetherimide/polyester blend chip includes the polyetherimide powder and the polyester powder, in which the polyetherimide powder has an amount greater than 70 wt % and less than or equal to 90 wt % based on a total weight of the polyetherimide powder and the polyester powder, and the polyester powder has an amount greater than or equal to 10 wt % and less than 30 wt % based on the total weight of the polyetherimide powder and the polyester powder. The polyetherimide/polyester blend chip made of the composition is amorphous.

According to one embodiment of the present disclosure, the polyetherimide powder has a diameter in a range of 10 μm to 600 μm, and the polyester powder has a diameter in a range of 10 μm to 600 μm.

According to one embodiment of the present disclosure, the polyester powder has a limiting viscosity in a range of 0.85 dl/g to 1.10 dl/g.

According to one embodiment of the present disclosure, the composition further includes an additive having an amount in a range of 0.01 wt % to 1.00 wt % based on the total weight of the polyetherimide powder and the polyester powder, and the additive is a polyalcohol, a polyolefin, a phenol-containing compound, or a combination thereof.

According to one embodiment of the present disclosure, the polyalcohol has a molecular weight in a range of 600 to 10,000.

The other composition for preparing the polyetherimide/polyester blend chip includes the polyetherimide powder, the polyester powder, and the additive. The polyetherimide powder has an amount greater than 65 wt % and less than or equal to 90 wt % based on a total weight of the polyetherimide powder and the polyester powder, and the polyester powder has an amount greater than or equal to 10 wt % and less than 35 wt % based on the total weight of the polyetherimide powder and the polyester powder. The additive has an amount in a range of 0.01 wt % to 1.00 wt % based on the total weight of the polyetherimide powder and the polyester powder, and the additive is a polyalcohol, a polyolefin, a phenol-containing compound, or a combination thereof. The polyetherimide/polyester blend chip made of the composition is amorphous.

The present disclosure further provides a method for preparing the polyetherimide/polyester blend chip, which includes providing the above-mentioned composition; performing a powder dispersion treatment on the composition; melt compounding the composition after performing the powder dispersion treatment; and pelletizing the composition after melt compounding the composition.

According to one embodiment of the present disclosure, providing the composition includes providing a polyetherimide chip and a polyester chip; and grinding the polyetherimide chip and the polyester chip to obtain the polyetherimide powder and the polyester powder.

According to one embodiment of the present disclosure, the powder dispersion treatment has a rotational speed in a range of 30 rpm to 30,000 rpm.

According to one embodiment of the present disclosure, melt compounding the composition has a melt compounding temperature in a range of 250° C. to 320° C. and a rotational speed in a range of 30 rpm to 300 rpm.

The present disclosure further provides a polyetherimide/polyester blend chip prepared by the above-mentioned method.

According to one embodiment of the present disclosure, the polyetherimide/polyester blend chip has a melt flow index (MI) greater than 20 when a melting temperature is 300° C. and a load is 5 kg.

The present disclosure further provides an article made of the above-mentioned polyetherimide/polyester blend chip.

According to one embodiment of the present disclosure, the article has a transmittance greater than or equal to 80% when a wavelength is 850 nm and a thickness of the article is 1 mm.

According to one embodiment of the present disclosure, the article is an optical connector element.

As mentioned above, the composition of the present disclosure can be used to produce the amorphous polyetherimide/polyester blend chip, which has good processability and optical-grade transparency, and thus can be used to fabricate the optical connector element.

### DETAILED DESCRIPTION

The present disclosure is described by the following specific embodiments. Those with ordinary skill in the arts can readily understand the other advantages and functions of the present invention after reading the disclosure of this specification. The present disclosure can also be implemented with different embodiments. Various details described in this specification can be modified based on different viewpoints and applications without departing from the scope of the present disclosure.

As used herein, the singular forms “a,” “an” and “the” include plural referents unless the context clearly dictates otherwise. Therefore, reference to, for example, a polyetherimide powder includes aspects having two or more such polyetherimide powders, unless the context clearly indicates otherwise.

The present disclosure provides a composition for preparing a polyetherimide/polyester blend chip, which includes a polyetherimide powder and a polyester powder. The polyetherimide powder has an amount greater than 70 wt % and less than or equal to 90 wt % based on a total weight of the polyetherimide powder and the polyester powder. The polyester powder has an amount greater than or equal to 10 wt % and less than 30 wt % based on the total weight of the polyetherimide powder and the polyester powder. The polyetherimide/polyester blend chip made of the composition is amorphous. The amorphous polyetherimide/polyester blend chip can be used to produce a transparent article, such as an optical connector element, specifically a fiber optic connector.

The term “polyetherimide” used herein refers to a polymer includes monomer units, and each of the monomer units includes an ether group and an imide group. In one embodiment, the polyetherimide is ULTEM PEI (available from Sabic Inc.), and the model may be PEI 1010, PEI 1000, or other suitable models.

The term “polyester” used herein refers to homo-polyester or co-polyester. The homo-polyester refers to polyester synthesized by condensation between one dicarboxylic acid with one diol. The co-polyester refers to polyester synthesized by condensation between one or more dicarboxylic acids with one or more diols. The polyester may have a general formula —[RC(O)OR′C(O)O]ₙ—, in which R and R′ may be hydrocarbons, such as alkyl, cycloalkyl, alkenyl, alkyny, or aromatic, and R and R′ may have one or more substituted groups. In one embodiment, the polyester is polyalkylene terephthalate, such as polyethylene terephthalate, polypropylene terephthalate, polybutylene terephthalate, other suitable polyalkylene terephthalate, or a combination thereof.

In one embodiment, the polyetherimide powder has a diameter in a range of 10 μm to 600 μm, and the polyester powder has a diameter in a range of 10 μm to 600 μm. The powder type can help mix the polyetherimide with the polyester uniformly. The following examples show that, under the premise of forming the amorphous polyetherimide/polyester blend chip, an amount of the polyester can be increased and that of the polyetherimide can be decreased by using the polyetherimide powder and the polyester powder compared to the use of a polyetherimide chip and a polyester chip, and thus material cost can be reduced.

In one embodiment, the polyester powder has a limiting viscosity in a range of 0.85 dl/g to 1.10 dl/g, and thus the prepared polyetherimide/polyester blend chip exhibits good mechanical property.

In one embodiment, the composition further includes an additive having an amount in a range of 0.01 wt % to 1.00 wt % based on the total weight of the polyetherimide powder and the polyester powder. The additive is a polyalcohol, a polyolefin, a phenol-containing compound or a combination thereof. The polyalcohol or the polyolefin may be acted as a dispersing agent, such as polymer WAX series, which has a lubricant effect to help disperse the polyetherimide with the polyester uniformly. The phenol-containing compound may be acted as a compatibilizer to increase capability between the polyetherimide and the polyester and thus to avoid phase separation.

The term “polyalcohol” used herein refers to an organic compound including one or more hydroxyl groups. The basic structure of the polyalcohol may be alkane, alkene, alkyne, cycloalkane, cycloalkene, aryl or heteroaryl, which may be substituted with other functional groups, such as carbonyl, primary amino, secondary amino, tertiary amino, sulfonyl, phosphono, carboxyl or other suitable functional groups. In one embodiment, the polyalcohol has a molecular weight in a range of 600 to 10,000. In one embodiment, the polyalcohol includes a polyether polyols, polyalkyl alcohols, or a combination thereof. The polyether polyols may be polyethylene glycol, polypropylene glycol, other suitable polyether polyols, or a combination thereof. The polyalkyl alcohols may be polyvinyl alcohol, polypropylene alcohol, other suitable polyalkyl alcohols or a combination thereof.

The term “polyolefin” refers to any polyolefin, such as straight, branched, cyclic, aliphatic, aromatic, substituted or unsubstituted polyolefin. Specifically, the polyolefin includes homopolymers of olefin, copolymers of olefin and non-olefin, such as polyethylene homopolymer, polypropylene homopolymer, polybutene homo-polymer, ethylene alpha-olefin copolymer, propylene alpha-olefin copolymer, butene alpha-olefin copolymer, ethylene unsaturated ester copolymer, ethylene unsaturated acid copolymer (e.g., ethylene ethyl acrylate copolymer, ethylene butyl acrylate copolymer, ethylene methyl acrylate copolymer, ethylene acrylic acid copolymer or ethylene methacrylic acid copolymer), ethylene vinyl acetate copolymer, ionomer resin, polymethylpentene, other suitable polyolefin, or a combination thereof.

The term “phenol-containing compound” refers to an organic compound including a phenol group. In one embodiment, the phenol-containing compound includes poly(bisphenol A-co-epichlorohydrin), glycidyl end-capped. In one embodiment, the phenol-containing compound includes a hindered phenol compound, such as 1,3,5-trimethyl-2,4,6-tris(3,5-di-tertbutyl-4-hydroxybenzyl)benzene (IRGANOX 1330, available from Ciba Geigy Co.), 3,5-di-tertbutyl-4-hydroxyhydrocinnamic acid triester with 1,3,5-tris(2-hydroxyethyl)-S-triazine-2,4,6-(1H,3H,5H)-trione (IRGANOX 3125, available from Ciba Geigy Co.), tetrakis[methylene-(3,5-di-tertbutyl-4-hydroxycinnimate)]methane (IRGANOX 1010, available from Ciba Geigy Co.), o,o-di-n-octadecyl-3,5-di-tertbutyl-4-hydroxy benzyl phosphonate (IRGANOX 1093, available from Ciba Geigy Co.), N,N′-1,6-hexanediyl bis[3,5-(1,1-dimethylethyl)-4-hydroxy benzene propanamide (IRGANOX 1098, available from Ciba Geigy Co.), 2,2′-oxamido bis-[ethyl-3-(3,5-di-tertbutyl-4-hydroxyphenyl)propionate] (NAUGARD XL-1, available from Crompton Co.), and 2-(tertbutyl)-6-methyl-4-[3-[[2,4,8,10-tetrakis(tertbutyl)dibenzo[d,f][1,3,2]dioxaphosphepin-6-yl]oxy]propyl]phenol (SUMILIZER GP available from Sumitomo Co.), other suitable hindered phenol compound, or a combination thereof.

The present disclosure further provides a composition for preparing a polyetherimide/polyester blend chip, which includes the polyetherimide powder, the polyester powder, and the additive. The polyetherimide powder has an amount greater than 65 wt % and less than or equal to 90 wt % based on a total weight of the polyetherimide powder and the polyester powder, and the polyester powder has an amount greater than or equal to 10 wt % and less than 35 wt % based on the total weight of the polyetherimide powder and the polyester powder. The additive has an amount in a range of 0.01 wt % to 1.00 wt % based on the total weight of the polyetherimide powder and the polyester powder. The additive is the polyalcohol, the polyolefin, the phenol-containing compound, or a combination thereof, which may be referred to those exemplified above. The polyetherimide/polyester blend chip made of the composition of the present disclosure is amorphous, and may be applied to produce a transparent article, such as an optical connector element. The following examples show that, under the premise of forming the amorphous polyetherimide/polyester blend chip, an amount of the polyester can be increased and that of the polyetherimide can be decreased by using the additive, and thus material cost can be reduced.

The present disclosure further provides a method for preparing the polyetherimide/polyester blend chip, which includes providing the above-mentioned composition; performing a powder dispersion treatment on the composition; melt compounding the composition after performing the powder dispersion treatment; and pelletizing the composition after melt compounding the composition.

In one embodiment, providing the composition includes providing a polyetherimide chip and a polyester chip; and then grinding the polyetherimide chip and the polyester chip to obtain the polyetherimide powder and the polyester powder. In one embodiment, the polyetherimide chip has a diameter in a range of 2 mm to 4 mm, and the polyester chip has a diameter in a range of 2 mm to 4 mm. A plastic mill may be used to grind the polyetherimide chip and the polyester chip to obtain the polyetherimide powder and the polyester powder. In one embodiment, the polyetherimide powder has a diameter in a range of 10 μm to 600 μm, and the polyester powder has a diameter in a range of 10 μm to 600 μm.

The powder dispersion treatment is performed before the composition is melt compounded. In one embodiment, the powder dispersion treatment is performed using a high-speed powder mixer with a rotational speed in a range of 30 rpm to 30,000 rpm to uniformly disperse the polyetherimide powder with the polyester powder before melt compounding.

In one embodiment, a drying treatment for removing water is performed on the powder before the composition is melt compounded and after the powder dispersion treatment is performed. In one embodiment, the drying treatment for removing the water is performed on the powder at 105° C. to 130° C.

In one embodiment, melt compounding the composition has a rotational speed in a range of 30 rpm to 300 rpm. In one embodiment, melt compounding the composition has a melt compounding temperature in a range of 250° C. to 320° C. In one embodiment, a twin-screw kneader is used to compound the composition. After the high-speed powder mixing and dispersing treatment is performed on the composition, the melt-compounded composition is pelletized to form the polyetherimide/polyester blend chip. Before pelletizing, the melt composition is cooled by cold water with a temperature in a range of 10° C. to 60° C., and then pelletized.

The present disclosure further provides a polyetherimide/polyester blend chip prepared by the above-mentioned method. In one embodiment, the polyetherimide/polyester blend chip has a melt flow index (MI) greater than 20, 30, or even 40 when a melting temperature is 300° C. and a load is 5 kg.

The present disclosure further provides an article made of the above-mentioned polyetherimide/polyester blend chip. In one embodiment, the article has a transmittance greater than or equal to 80% when a wavelength is 850 nm and a thickness of the article is 1 mm.

In one embodiment, the article is an optical connector element made of the above-mentioned polyetherimide/polyester blend chip, such as a fiber optic connector. In one embodiment, the fiber optic connector has a semicircular mirror, and has attenuation in a range of −1.3 to −1.4 when an optical current is 10 mA.

### EXAMPLES

The following Examples are provided to illustrate certain aspects of the present disclosure and to aid those of skill in the art in practicing this disclosure. These Examples are in no way to be considered to limit the scope of the disclosure in any manner.

### Comparative Examples 1-10

### Polyetherimide/Polyester Blend Chips without Additives

A polyetherimide chip (ULTEM PEI 1010, purchased from Sabic Inc.) and a polyester chip (U25961, purchased from Sinkong Synthetic Fiber Corp.) were respectively grinded to form powders. Next, compositions of Comparative Examples 1-10 were respectively prepared with various ratios of the polyetherimide powder and the polyester powder according to Table 1. The composition was dispersed by a high-speed grinder with 5,000 rpm for 20 mins, and then dried at a processing temperature of 105° C. for 8 hours. The obtained composition was compounded using a twin-screw kneader and then pelletized with a rotational speed of 250 rpm to obtain the polyetherimide/polyester blend chips with different compositions. Glass transition temperature (Tg), crystallization temperature (Tc), and melting point (Tm) of the polyetherimide/polyester blend chips were tested using a differential scanning calorimetry (DSC) and thus to evaluate its crystallinity. In addition, transparency of the polyetherimide/polyester blend chips was evaluated through visual observation. The compositions and characteristics of Comparative Examples 1-10 were listed in Table 1.

TABLE 1

| | PEI | PET | Tg | Tc | Tm | Crys- | Trans- |
|---|---|---|---|---|---|---|---|
| | (wt %) | (wt %) | (° C.) | (° C.) | (° C.) | tallinity | parency |
| Comparative | 0 | 100 | N/A | N/A | 251.8 | containing | misty |
| Example 1 | | | | | | crystals | |
| Comparative | 5 | 95 | 85.8 | N/A | 122.3 | containing | misty |
| Example 2 | | | | | 255.0 | crystals | |
| Comparative | 10 | 90 | 88.0 | 134.9 | 255.2 | containing | misty |
| Example 3 | | | | | | crystals | |
| Comparative | 20 | 80 | 90.7 | 156.3 | 256.2 | containing | misty |
| Example 4 | | | | | | crystals | |
| Comparative | 30 | 70 | 93.3 | 166.7 | 253.6 | containing | misty |
| Example 5 | | | | | | crystals | |
| Comparative | 40 | 60 | N/A | 230.0 | 176.6 | containing | misty |
| Example 6 | | | | | 254.8 | crystals | |
| Comparative | 50 | 50 | N/A | 230.0 | 173.4 | containing | misty |
| Example 7 | | | | | 254.5 | crystals | |
| Comparative | 60 | 40 | 135.3 | 230.0 | 250.7 | containing | trans- |
| Example 8 | | | | | | crystals | parent |
| Comparative | 70 | 30 | 148.7 | N/A | 250.0 | containing | trans- |
| Example 9 | | | | | | crystals | parent |
| Comparative | 100 | 0 | 220.0 | N/A | N/A | amorphous | trans- |
| Example 10 | | | | | | | parent |

As shown in Table 1, if the amount of the polyetherimide is higher, the polyetherimide/polyester blend chip tends to be amorphous state. In the absence of the use of additives, the amount of the polyetherimide may be greater than or equal to 60 wt % to let the polyetherimide/polyester blend chip be transparent. The amount of the polyetherimide may be greater than 70 wt % to let the polyetherimide/polyester blend chip be amorphous.

### Comparative Example 11

### Additive-Containing Polyetherimide/Polyester Blend Chip without Powder Treatment

A polyetherimide chip and a polyester chip were mixed and dried at 105° C. for 8 hours, and then compounded using a twin-screw kneader and then pelletized with a rotational speed of 250 rpm to obtain the polyetherimide/polyester blend chip of Comparative Example 11.

### Comparative Example 12 and Examples 1-4

### Additive-Containing Polyetherimide/Polyester Blend Chips

A polyetherimide chip and a polyester chip were respectively grinded to form powders, which is the same as that of Comparative Examples 1-10. Next, compositions of Comparative Example 12 and Examples 1-4 were respectively prepared with various ratios of polyetherimide powder, the polyester powder and the additive according to Table 2. The formulation of the additive is shown in remarks beneath Table 2. The composition was dispersed by a high-speed grinder with 5,000 rpm for 20 mins, and then dried at a processing temperature of 105° C. for 8 hours. The obtained composition was compounded using a twin-screw kneader and then pelletized with a rotational speed of 250 rpm to obtain the polyetherimide/polyester blend chips with different compositions. Glass transition temperature (Tg), crystallization temperature (Tc), and melting point (Tm) of the polyetherimide/polyester blend chips of Comparative Examples 11-12 and Examples 1-4 were tested using a DSC and thus to evaluate its crystallinity. In addition, transparency of the polyetherimide/polyester blend chips was evaluated through visual observation. The compositions and characteristics of Comparative Examples 11-12 and Examples 1-4 were listed in Table 2.

TABLE 2

| | PEI | PET | Additive | Tg | Tc | Tm | | |
|---|---|---|---|---|---|---|---|---|
| | (wt %) | (wt %) | (wt %) | (° C.) | (° C.) | (° C.) | Crystallinity | Transparency |
| Comparative | 70 | 30 | 0.1^{a} | 144.3 | N/A | 269.7 | containing | transparent |
| Example 11 | | | | | | | crystals | |
| Comparative | 65 | 35 | 0.1^{b} | 147.6 | N/A | 251.0 | containing | transparent |
| Example 12 | | | | | | | crystals | |
| Example 1 | 70 | 30 | 0.1^{a} | 148.7 | N/A | N/A | amorphous | transparent |
| Example 2 | 70 | 30 | 0.1^{b} | 149.3 | N/A | N/A | amorphous | transparent |
| Example 3 | 70 | 30 | 0.1^{c} | 150.0 | N/A | N/A | amorphous | transparent |
| Example 4 | 80 | 20 | 0.1^{a} | 162.6 | N/A | N/A | amorphous | transparent |

Remarks:
^{a}The additive includes a polyalcohol and a phenol-containing compound with a weight ratio of 1:1
^{b}The additive is the phenol-containing compound
^{c}The additive is the polyalcohol

The polyalcohol is polyethylene glycol with a molecular weight of 1,000, and the phenol-containing compound is poly(bisphenol A-co-epichlorohydrin), glycidyl end-capped.

As shown in Comparative Example 11 and Examples 1-3 of Table 2, the powder treatment indeed can help make the polyetherimide/polyester blend chip amorphous. In addition, as shown in Comparative Example 9 of Table 1 and Examples 1-3 of Table 2, the use of the additive indeed can help make the polyetherimide/polyester blend chip amorphous.

A flowability test was performed on Example 1 and Comparative Example 10. Example 1 has MI of 96 and Comparative Example 10 has MI of 13 at 340° C. with a load of 5 kg. The result demonstrates that the composition of Example 1 has better flowability. Further, Example 1 has MI of 50 at 320° C. with a load of 5 kg.

A processability test was performed on Example 1 and Comparative Example 10. The compositions of Example 1 and Comparative Example 10 were respectively injection molded. In Example 1, three heating zones and a nozzle of an injection molding machine respectively have temperatures of 320° C., 330° C., 350° C., and 350° C. In Comparative Example 10, the three heating zones and the nozzle of the injection molding machine respectively have temperatures of 350° C., 360° C., 380° C., and 380° C. The result shows that Example 1 can be processed at lower temperature and thus have better processability. It is worth mentioning that, according to the MI of Example 1 and Comparative Example 10, the processing temperature of Example 1 was predicted, able to be reduced to 250° C. to 320° C.

A transmittance test was performed on Example 1 and Comparative Example 10. Each of the blend chips of Example 1 and Comparative Example 10 was injection molded to form an article with a thickness of 1 mm. Next, transmittance of the article was tested by a UV-visible spectrometer. The article of Example 1 has a transmittance of 88% with a light wavelength of 850 nm, which is similar to that of Comparative Example 10.

An attenuation test through optical current was performed on Example 1 and Comparative Example 10. The blend chips of Example 1 and Comparative Example 10 were respectively processed to form fiber optic connectors. The fiber optic connector has a semicircular mirror. The fiber optic connector of Example 1 has attenuation in a range of −1.3 to −1.4 when an optical current is 10 mA, which is similar to that of Comparative Example 10.

As mentioned above, the composition for preparing the polyetherimide/polyester blend chip of the present disclosure can let the article have excellent transparency, flowability, processability and light transmittance, and its optical property is similar to that of pure polyetherimide. Accordingly, the composition of the present disclosure is able to replace pure polyetherimide and thus to significantly reduce cost.

It will be apparent to those ordinarily skilled in the art that various modifications and variations may be made to the structure of the present disclosure without departing from the scope or spirit of the invention. In view of the foregoing, it is intended that the present disclosure cover modifications and variations thereof provided they fall within the scope of the following claims.

What is claimed is:

1. A composition for preparing a polyetherimide/polyester blend chip, comprising:
a polyetherimide powder; and
a polyester powder, wherein the polyetherimide powder has an amount greater than 70 wt % and less than or equal to 90 wt % based on a total weight of the polyetherimide powder and the polyester powder, and the polyester powder has an amount greater than or equal to 10 wt % and less than 30 wt % based on the total weight of the polyetherimide powder and the polyester powder,
wherein the polyetherimide/polyester blend chip made of the composition is amorphous.

2. The composition for preparing the polyetherimide/polyester blend chip of claim 1, wherein the polyetherimide powder has a diameter in a range of 10 μm to 600 μm, and the polyester powder has a diameter in a range of 10 μm to 600 μm.

3. The composition for preparing the polyetherimide/polyester blend chip of claim 1, wherein the polyester powder has a limiting viscosity in a range of 0.85 dl/g to 1.10 dl/g.

4. The composition for preparing the polyetherimide/polyester blend chip of claim 1, further comprising:
an additive, having an amount in a range of 0.01 wt % to 1.00 wt % based on the total weight of the polyetherimide powder and the polyester powder, and the additive being a polyalcohol, a polyolefin, a phenol-containing compound or a combination thereof.

5. The composition for preparing the polyetherimide/polyester blend chip of claim 4, wherein the polyalcohol has a molecular weight in a range of 600 to 10,000.

6. A composition for preparing a polyetherimide/polyester blend chip, comprising:
a polyetherimide powder;
a polyester powder, wherein the polyetherimide powder has an amount greater than 65 wt % and less than or equal to 90 wt % based on a total weight of the polyetherimide powder and the polyester powder, and the polyester powder has an amount greater than or equal to 10 wt % and less than 35 wt % based on the total weight of the polyetherimide powder and the polyester powder; and
an additive, having an amount in a range of 0.01 wt % to 1.00 wt % based on the total weight of the polyetherimide powder and the polyester powder, and the additive being a polyalcohol, a polyolefin, a phenol-containing compound or a combination thereof,
wherein the polyetherimide/polyester blend chip made of the composition is amorphous.

7. A method for preparing a polyetherimide/polyester blend chip, comprising:
providing the composition of claim 1;
performing a powder dispersion treatment on the composition;
melt compounding the composition after performing the powder dispersion treatment; and
pelletizing the composition after melt compounding the composition.

8. The method for preparing the polyetherimide/polyester blend chip of claim 7, wherein providing the composition comprises:
providing a polyetherimide chip and a polyester chip; and
grinding the polyetherimide chip and the polyester chip to obtain the polyetherimide powder and the polyester powder.

9. The method for preparing the polyetherimide/polyester blend chip of claim 7, wherein the powder dispersion treatment has a rotational speed in a range of 30 rpm to 30,000 rpm.

10. The method for preparing the polyetherimide/polyester blend chip of claim 7, wherein melt compounding the composition has a melt compounding temperature in a range of 250° C. to 320° C. and a rotational speed in a range of 30 rpm to 300 rpm.

11. A polyetherimide/polyester blend chip prepared by the method of claim 7.

12. The polyetherimide/polyester blend chip of claim 11, wherein the polyetherimide/polyester blend chip has a melt flow index (MI) greater than 20 when a melting temperature is 320° C. and a load is 5 kg.

13. An article made of the polyetherimide/polyester blend chip of claim 11.

14. The article of claim 13, wherein the article has a transmittance greater than or equal to 80% when a wavelength is 850 nm and a thickness of the article is 1 mm.

15. The article of claim 13, wherein the article is an optical connector element.
